(19) United States
(12) Patent Application Publication
(10) Pub. No.: US 2007/0058126 A1
(43) Pub. Date: Mar. 15, 2007

(54) Liquid crystal display panel and manufacturing method thereof

(75) Inventors: Woo Sik Cho, Seoul (KR); Yun Seok Lee, Cheonan-si (KR); Young Je Cho, Cheonan-si (KR); Cheon Jae Maeng, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/520,081

(22) Filed: Sep. 13, 2006

(30) Foreign Application Priority Data
Sep. 13, 2005 (KR) 2005-84982

(51) Int. Cl. G02F 1/1339

(52) U.S. Cl. 349/156

(57) ABSTRACT

A liquid crystal panel and a manufacturing method thereof which can ensure the uniformity of a cell gap. The liquid crystal panel includes first and second substrates assembled by a seal line with a liquid crystal interposed therebetween, and column spacers of which tilt angles are differently formed according to their locations, thereby maintaining a cell gap constant between the first and second substrates.

### CROSS REFERENCE TO RELATED PATENT APPLICATION

This application claims the benefit to Korean Patent Application No.: 10-2005-0084982, filed on Sep. 13, 2005, in the Korean Intellectual Property Office, the disclosure of which is incorporated herein in its entirety by reference.

### BACKGROUND OF THE INVENTION

1. Technical Field

The present disclosure relates to a liquid crystal display panel, and more particularly, to a liquid crystal display panel which is capable of preventing its cell gap from becoming nonuniform, and a manufacturing method for such a liquid crystal display panel.

2. Discussion of the Related Art

A liquid crystal display device displays images by adjusting the light transmittance of a liquid crystal having dielectric anisotropy by use of an electric field. To achieve this, the liquid crystal display device includes a liquid crystal display panel (hereinafter, referred to as liquid crystal panel) for displaying images through a liquid crystal cell matrix, and a driving circuit for driving the liquid crystal panel.

Referring to FIG. 1, a conventional liquid crystal panel includes an upper substrate 12 and a lower substrate 10 which are assembled to each other by a seal line 16 with a liquid crystal interposed therebetween.

The upper substrate 12 includes a black matrix and a color filter formed on an insulating substrate and also includes a common electrode. The black matrix, which is formed in a matrix shape, prevents light leakage and separates a liquid crystal cell region into sub-pixel units. The color filter formed in the liquid crystal cell region is divided into red (R), green (G) and blue (B) and that pass R, G and B light, respectively. The common electrode provides a common voltage that becomes a reference voltage while the liquid crystal is driven.

The lower substrate 10 includes gate and data lines formed on a lower insulating substrate that intersect with each other, pixel electrodes formed in every liquid crystal Is cell region divided by the intersection of the gate and data lines, and thin film transistors connected between the gate and data lines and the pixel electrodes. The thin film transistor supplies the pixel electrode with a data signal received from the data line in response to a scan signal received from the gate line.

By the above-described configuration, a pixel voltage which is a difference voltage between the common voltage supplied to the common electrode and the data signal supplied to the pixel electrode is charged to the liquid crystal cell, and the liquid crystal having dielectric anisotropy is driven according to the pixel voltage to adjust light transmittance, thereby achieving a gray level.

An alignment film for determining the alignment of the liquid crystal is formed on the uppermost layer of each of the upper substrate 12 and lower substrate 10.

The liquid crystal panel additionally includes column spacers 14 for constantly maintaining a cell gap between the upper and lower substrates 12 and 10. The column spacers 14 are generally used in a large-sized liquid crystal panel to which a liquid crystal forming method of a drop-filling technique is applied. The column spacers 14 are mainly formed on an overcoat layer for covering the color filter of the upper substrate 12.

In more detail, the liquid crystal panel to which a liquid crystal drop-filling technique is applied is formed by drop-filling the liquid crystal on the lower substrate 10, and the seal line 16 surrounding the peripheral part of the upper substrate 12 is formed on the upper substrate 12 when the column spacers 14 are formed. Thereafter, the upper and lower substrates 12 and 10 are assembled.

However, in an assembling process of the upper and lower substrates 12 and 10 implemented under atmospheric pressure, a cell gap becomes nonuniform, as shown in a cell gap graph of FIG. 2, by a load applied upon the liquid crystal panel.

As represented in FIG. 2, the cell gap becomes smaller in the center than at the sides of the liquid crystal panel. This is because at the sides of the liquid crystal panel the load is distributed by being supported by the seal line 16 and the column spacers 14, whereas in the center of the liquid crystal panel the load is not distributed and is supported only by the column spacers 14. Therefore, the centrally located column spacer 14 of the liquid crystal panel is compressed more than the laterally located column spacer 14 thereof and thus the cell gap at the center of the liquid crystal panel becomes smaller than the cell gap at the sides of the liquid crystal panel.

As a result, the conventional liquid crystal panel creates a defect in picture quality due to the nonuniformity of the cell gap so that images become brighter or darker toward the sides of the liquid crystal panel relative to the center of the liquid crystal panel. Furthermore, the larger the liquid crystal panel is, the more severe the defect in picture quality becomes due to the nonuniformity of the cell gap. Therefore, a technique has been demanded for solving the nonuniformity problem of the cell gap.

### SUMMARY OF THE INVENTION

In accordance with an exemplary embodiment of the present invention, there is provided a liquid crystal panel including first and second substrates assembled by a seal line with a liquid crystal interposed therebetween, and column spacers having side tilt angles that are differently formed according to their locations, thereby maintaining a cell gap between the first and second substrates substantially constant.

In other words, the liquid crystal panel according to an embodiment of the present invention includes first and second substrates assembled by a seal line with a liquid crystal interposed therebetween, and column spacers having compressive strains that are smaller in the center than at the sides adjacent to the seal line, thereby maintaining a cell gap between the first and second substrates substantially constant.

In accordance with an exemplary embodiment of the present invention, there is provided a method for manufacturing a liquid crystal panel, including the steps of forming column spacers in which side tilt angles are different according their locations on any one of first and second substrates, forming a seal line on any one of the first and second substrates, forming a liquid crystal layer on any one of the first and second substrates, and assembling the first and second substrates.

### BRIEF DESCRIPTION OF THE DRAWINGS

Exemplary embodiments of the present invention can be understood in more detail from the following description taken in conjunction with the accompanying drawings in which:

FIG. 1 is a sectional view schematically showing a structure of a conventional liquid crystal panel;

FIG. 2 is a graph showing the height of a cell gap according to the location of the conventional liquid crystal panel;

FIG. 3 is a sectional view schematically showing a structure of a liquid crystal panel according to an embodiment of the present invention;

FIG. 4 is a view separately showing regions of a liquid crystal panel where column spacers shown in FIG. 3 are formed;

FIG. 5 is a sectional view showing a color filter substrate according to an embodiment of the present invention; and

FIG. 6 is a sectional view showing a forming process of column spacers illustrated in FIG. 5.

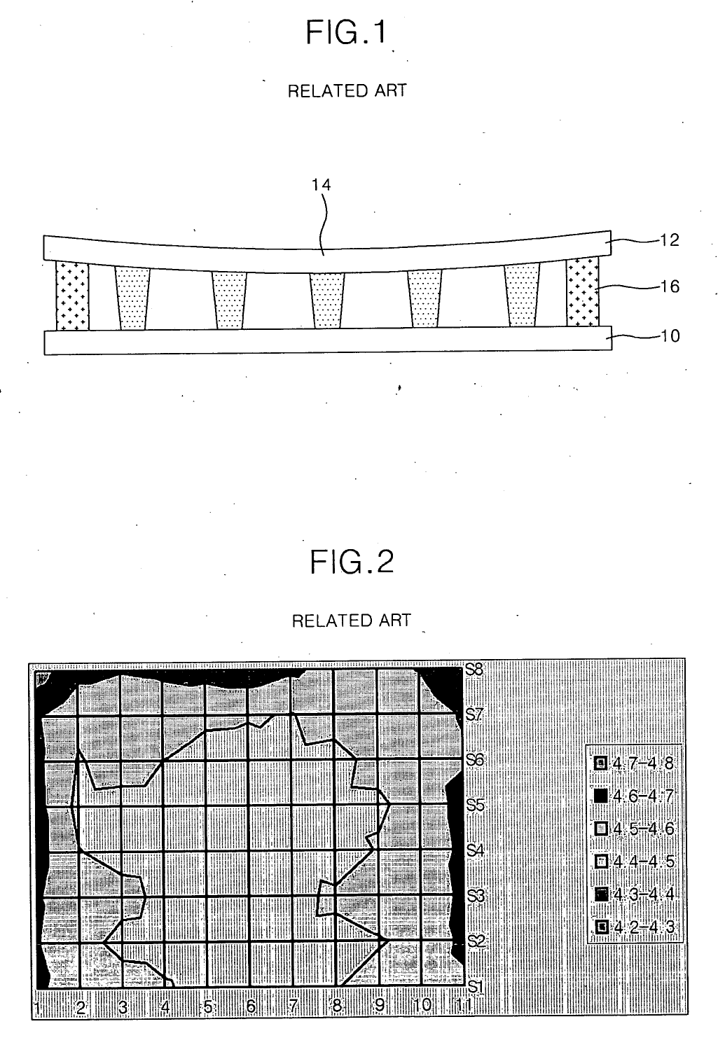

### DETAILED DESCRIPTION OF EXEMPLARY EMBODIMENTS

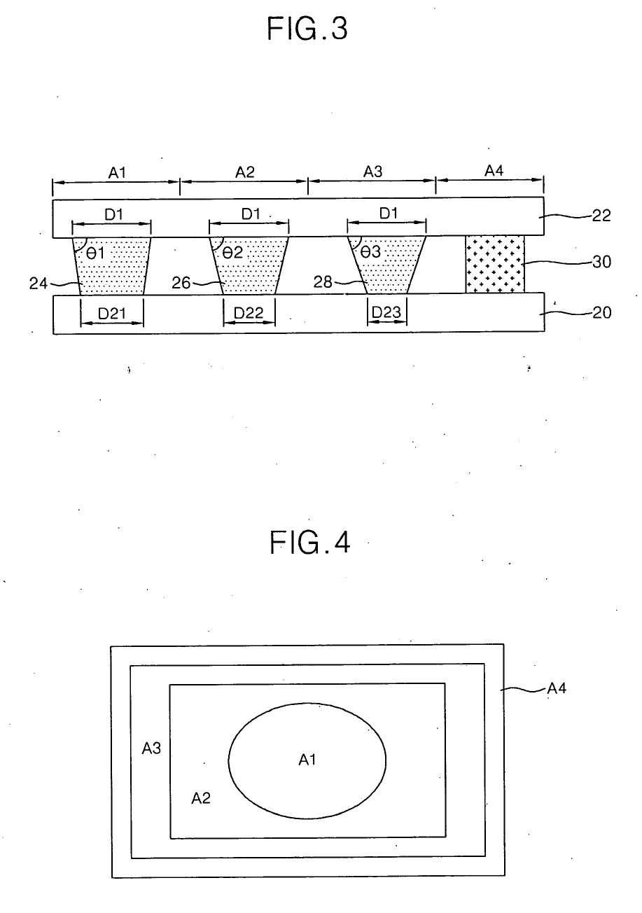

An embodiment of the present invention will be described hereinbelow with reference to FIGS. 3 to 6.

FIG. 3 is a sectional view of a liquid crystal panel employing column spacers, and FIG. 4 is a view showing separate regions of a liquid crystal panel where the column spacers shown in FIG. 3 are formed.

The liquid crystal panel shown in FIG. 3 includes an upper substrate 22 and a lower substrate 20 that are assembled by a seal line 30 with a liquid crystal (not shown) interposed therebetween, and includes a plurality of column spacers, three of which are shown at 24, 26 and 28 formed between the upper and lower substrates 22 and 20.

The upper substrate 22 may include a black matrix (not shown) and a color filter (not shown) formed on an insulating substrate. The black matrix which may be formed in a matrix shape prevents light leakage and separate a liquid crystal cell region into sub-pixel units. The color filter formed in the liquid crystal cell region may be divided into red (R), green (G) and blue (B) and pass R, G and B light, respectively. If the liquid crystal panel uses a liquid crystal of a TN (Twisted Nematic) mode or VA (Vertical Alignment) mode, a common electrode may be formed on the color filter. The common electrode provides a common voltage which becomes a reference voltage while the liquid crystal is driven.

The lower substrate 20 may include gate and data lines (not shown) formed on a lower insulating substrate that intersect with each other, pixel electrodes formed in every liquid crystal cell region separated by the intersection of the gate and data lines, and thin film transistors connected between the gate and data lines and the pixel electrodes. The thin film transistor supplies the pixel electrode with a data signal received from the data line in response to a scan signal received from the gate line. If the liquid crystal panel is an IPS (In-Plane Switching) mode or an FFS (Fringe Field Switching) mode, a common electrode may be provided for forming a horizontal or fringe electric field with the pixel electrode.

A pixel voltage that is a difference voltage between the common voltage supplied to the common electrode and the data signal supplied to the pixel electrode is charged to the liquid crystal cell, and the liquid crystal having dielectric anisotropy is driven according to the pixel voltage to adjust light transmittance, thereby achieving a gray level.

An alignment film for determining the alignment of the liquid crystal is formed on the uppermost layer of each of the upper substrate 22 and lower substrate 20.

The column spacer 21 is represented by the three column spacers 24, 26 and 28 shown in FIG. 3 for determining a cell gap between the upper and lower substrates 22 and 20 are formed on the upper substrate 22 or the lower substrate 20. The column spacers 24, 26 and 28 are overlapped with, that is, are located at the same place as, the black matrix in order to prevent an aperture ratio from being reduced. The column spacers 24, 26 and 28 can be formed in various shapes such as a prismoid and a truncated cone close to a hemisphere. For convenience, the vertical cross section of each of the simplified column spacers 24, 26 and 28 is shown in FIG. 3. On the other hand, the column spacer may be formed in different shape.

The column spacers 24, 26 and 28 are formed to have different side tilt angle θ_{ST} according to their location in the liquid crystal panel. And each of the side tilt angle θ_{ST} of the three column spacers is symbolized by θ1, θ2 and θ3 in FIG. 3. The side tilt angle θ_{ST} is an interior angle between the longer bottom side D1 of the both bottom sides, which are sides in contact with the first and second substrates respectively, of the column spacer 21 and lateral side LS of the column spacer 21. If both of the bottom sides have an equal length, then the side tilt angle may be the interior angle between one bottom side and lateral side of the column spacer. In more detail, the side tilt angle of the column spacer in a region distant from the seal line is larger than the side tilt angle of the column spacer in another region close to the seal line. In other words, the side tilt angles of the plurality of column spacers gradually increase as the column spacers become more distant from the seal line. The side tilt angles θ1, θ2 and θ3 of the column spacers 24, 26 and 28 can be adjusted within the range of from 90 degrees (a maximum value in which the lateral side is at right angle with the bottom side) to 30 degrees (a minimum value by which the column spacer can be supported).

Compressive strains of the column spacers 24, 26 and 28 caused by a load vary with the side tilt angles θ1, θ2 and θ3. That is, as a side tilt angle θ of the column spacer increases, a compressive strain δ of the column space is reduced as indicated in Expression (1):

$$δ = \frac{4 P}{π E} \cdot \frac{L}{D 1 ( D 1 + 2 L tan {θ}^{′} )} = \frac{4 PL}{π E D 1 D 2} \\ ( where tan {θ}^{′} = \frac{D 2 - D 1}{2 L} , {θ}^{′} = 90 ° - θ ) \qquad Expression ( 1 )$$

In Expression (1), it is assumed that the horizontal cross section of the column spacer is a circle, θ′ is a side tilt angle based on a vertical axis (that is, θ=90°−θ′), D1 is the diameter of the bigger bottom side of the column spacer, D2 (D2 comprises the D21, D22 and D23 shown in FIG. 3) are the diameter of the smaller bottom side of the column space, L is the height of the column spacer, P is a load applied upon the column spacer, and E is Young's coefficient.

If it is assumed that the column spacers 24, 26 and 28 have the same heights and that the same loads are applied upon them, the compressive strain δ of each of the column spacers 24, 26 and 28 is determined by the side tilt angle θ′ based on the vertical axis, that is, the side tilt angle θ based on the bottom side, and the side tilt angle θ is again determined by the difference between the bottom diameter D1 and top diameter D2 of each of the column spacers 24, 26 and 28. In other words, the compressive strain δ of each of the column spacers 24, 26 and 28 decreases, as the side tilt angle θ increases (namely, as θ′ decreases), that is, as the difference between the bottom diameter D1 and the top diameter D2 of each of the column spacers 24, 26 and 28 decreases. Here, under the assumption that the column spacers 24, 26 and 28 are formed on the upper substrate 22, it is defined that a part where the column spacers 24, 26 and 28 are in contact with the upper substrate 22 is the bottom and a part where the column spacers 24, 26 and 28 are in contact with the lower substrate 20 is the top.

In order to prevent a cell gap of a liquid crystal panel from becoming nonuniform due to the compressive strains of the column spacers 24, 26 and 28 caused by a load, the compressive strains 6 of the column spacers 24, 26 and 28 should be reduced as the column spacers 24, 26 and 28 progress toward the center from the sides of the liquid crystal panel. For this, the column spacers 24, 26 and 28 are formed such that their side tilt angles increase, that is, the difference between the bottom diameter D1 and the top diameter D2 of each of the column spacers 24, 26 and 28 gradually decreases, as they progress toward the center from the sides of the liquid crystal panel. If the horizontal cross section of each of the column spacers 24, 26 and 28 is not a circle but a polygon including a quadrangle, D1 may be the width of the bigger bottom side and D2 may be the width of the smaller bottom side, if the column spacer is formed as a prismoidal shape. In other words, the column spacers 24, 26 and 28 are formed such that a ratio of the top area to the bottom area of each of the column spacers 24, 26 and 28 decreases as the column spacers 24, 26 and 28 progress toward the center from the sides of the liquid crystal panel.

For example, the first column spacer 24 having the first side tilt angle θ1, the largest angle, is formed in a first region A1 located in the center of the liquid crystal panel as shown in FIG. 4. The second column spacer 26 having the second side tilt angle θ2 smaller than the first side tilt angle θ1 is formed in a second region A2 surrounding the first region A1. The third column spacer 28 having the third side tilt angel θ3 smaller than the second side tilt angle θ2 is formed in a third region A3 adjacent to the seal line 30, that is, in the third region A3 between the second region A2. A fourth region A4 is provided where the seal line 30 is formed.

In summary, the first to third column spacers 24, 26 and 28 formed in the first to third regions A1, A2 and A3 of the liquid crystal panel are formed such that their side tilt angles are reduced in order of θ1>θ2>θ3. In other words, the bottom diameters D1 of the column spacers 24, 26 and 28 are identically set and the top diameters D21, D22 and D23 thereof are reduced in order of D21>D22>D23. That is, the bottom areas of the first to third column spacers 24, 26 and 28 are identically set and the top areas thereof are formed to be reduced in order of the first, second and third column spacers.

Therefore, the compressive strain caused by a load of the centrally located column spacer of the liquid crystal panel is smaller than that of the laterally located column spacer, and thus the ununiformity of the cell gap due to the deformation of the spacers 24, 26 and 28 can be prevented.

If those column spacers 24, 26 and 28 are formed on the upper substrate 22, the seal line 30 surrounding the outer part of the upper substrate 22 is formed on the upper substrate 22, and a liquid crystal is formed on the lower substrate 20 by a drop-filling method. Then the upper and lower substrates 22 and 20 are assembled to each other, thereby completing the liquid crystal panel.

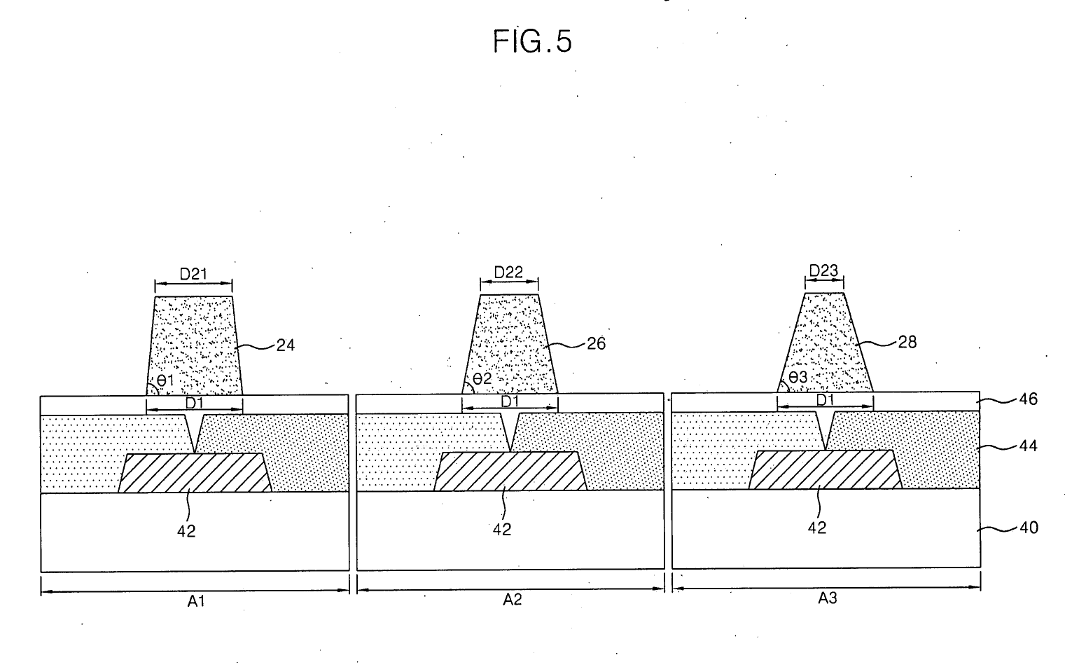

FIG. 5 is a sectional view illustrating a structure of an upper substrate of a liquid crystal panel according to an exemplary embodiment of the present invention, and shows a sectional structure of the upper substrate where the column spacers 24, 26 and 28 shown in FIG. 3 are formed. Note that FIG. 3 is shown inverted in FIG. 5.

Referring to FIG. 5, the upper substrate includes a black matrix 42 and a color filter 44 formed on an insulating substrate 40. The black matrix 42 which may be formed in a matrix shape may prevent light leakage and separate a liquid crystal cell region into sub-pixel units. The color filter 44 formed in the liquid crystal cell region is divided into R, G and B sections that pass R, G and B light, respectively. An overcoat layer 46 may be further formed on a flat surface of the color filter 44.

The column spacers 24, 26 and 28 may be formed on the overcoat layer 46. If there is no overcoat layer 46, they may be formed on the color filter 44 so as to be overlapped with the black matrix 42. The column spacers 24, 26 and 28 may be formed to decrease in their side tilt angles in order of θ1>θ2>θ3 as they progress toward the third region A3 at the sides of the liquid crystal panel from the first region A1 at the center thereof. In other words, if the horizontal cross section of each of the first to third column spacers 24, 26 and 28 is a circle, the column spacers 24, 26 and 28 may be formed to have the substantially same bottom diameters D1 and the substantially same heights, however, their top diameters D21, D22 and D23 may be formed to be reduced in order of D21>D22>D23. However, if the horizontal section of each of the first to third column spacers 24, 26 and 28 is not a circle but a polygon, the column spacers 24, 26 and 28 may be formed to have the same width of the bigger bottom sides and the same heights and their width of the smaller bottom sides D21, D22 and D23 may be formed to be reduced in order of D21>D22>D23. Consequently, the first to third column spacers 24, 26 and 28 have the same bottom areas and the same heights, and their top areas are formed to be reduced in order of first, second and third column spacers.

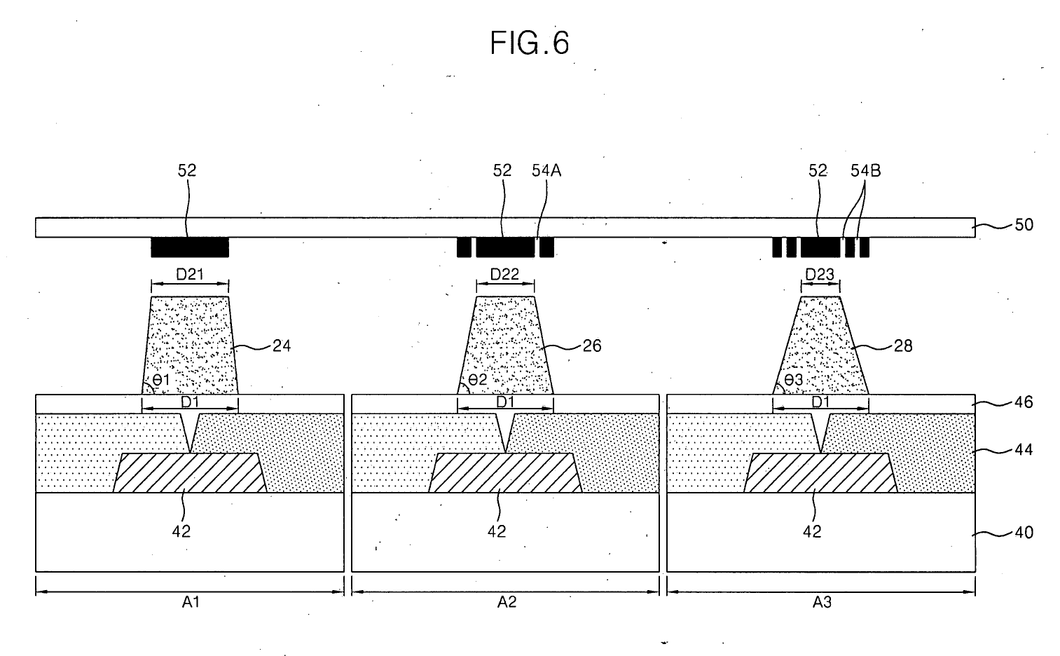

Those first to third column spacers 24, 26 and 28 having the different side tilt angles θ1, θ2, θ3 may be formed through a patterning process by using a diffraction exposure mask as shown in FIG. 6.

Referring to FIG. 6, the black matrix 42, color filter 44 and overcoat layer 46 are formed on the insulating substrate 40, and the first to third column spacers 24, 26 and 28 having the different side tilt angles θ1, θ2, θ3 are formed on the overcoat layer 46 in the regions A1, A2 and A3.

The first to third column spacers 24, 26 and 28 are formed by coating a column spacer material on the overcoat layer 46 and patterning the spacer material by a photolithographic process and an etching process using a diffraction exposure mask. An organic insulating material such as an epoxy acryl resin may be used as the column spacer material.

The diffraction exposure mask includes a block pattern 52 for forming the column spacers 24, 26 and 28 on a transparent substrate 50, and slit patterns 54A and 54B for determining the side tilt angles θ1, θ2 and θ3 of the column spacers 24, 26 and 28 by penetrating the outer part of the block pattern 52.

The first column spacer 24 having the first side tilt angle θ1 is formed on an ultraviolet block region caused by the block pattern 52 of the diffraction exposure mask at the first region A1.

The second column spacer 26 is formed on the ultraviolet block region caused by the block pattern 52 of the diffraction exposure mask at the second region A2. The second column spacer 26 has the second side tilt angle θ2 smaller than the first side tilt angle θ1 by the diffraction exposure caused by the first slit patterns 54A formed in the outer part of the block pattern 52. In other words, the second column spacer 26 formed in the second region A2 has the same bottom diameter D1 as the first column spacer 24 formed in the first region A1 and has the top diameter D22 smaller than the top diameter D21 of the first column spacer 24.

The third column spacer 28 is formed on the ultraviolet block region caused by the block pattern 52 of the diffraction exposure mask at the third region A3. The third column spacer 28 has the third side tilt angle θ3 smaller than the second side tilt angle θ2 by the diffraction exposure caused by the second slit patterns 54B larger in number than the first slit patterns 54A formed in the outer part of the block pattern 52. In other words, the third column spacer 26 formed in the third region A3 has the same bottom diameter D1 as the second column spacer 26 formed in the second region A2 and has the top diameter D23 smaller than the top diameter D22 of the second column spacer 26.

Thereafter, either the common electrode (not shown) and alignment layer (not shown) or the alignment layer (not shown) may be additionally formed on the upper substrate where the column spacers 24, 26 and 28 are formed.

Therefore, a manufacturing method of the liquid crystal panel according to the exemplary embodiment of the present invention can form by a single patterning process the column spacers 24, 26 and 28 of which side tilt angles θ1, θ2 and θ3 decrease, that is, of which top diameters (or lengths, widths) D21, D22 and D23 decrease with respect to the same bottom diameters (or lengths, widths) D1, as the column spacers 24, 26 and 28 progress toward the sides from the center of the liquid crystal panel. Those column spacers 24, 26 and 28 may be formed on either the upper substrate or the lower substrate by the above-described method.

If the column spacers 24, 26 and 28 are formed in the upper substrate, the seal line surrounding the outer part of the upper substrate may be formed on the upper substrate and a liquid crystal may be formed on the lower substrate by a drop-filling technique. Thereafter, the upper and lower substrates are assembled to each other, thereby completing the liquid crystal panel.

If the column spacers 24, 26 and 28 are formed in the lower substrate, the seal line surrounding the outer part of the lower substrate may be formed on the lower substrate and a liquid crystal may be formed on the upper substrate by a drop-filling technique. Thereafter, the upper and lower substrates are assembled to each other, thereby completing the liquid crystal panel.

As described above, since the liquid crystal panel and manufacturing method thereof according to the exemplary embodiments of the present invention include the column spacers of which side tilt angles increase, that is, of which top areas increase with respect to the bottom areas as the column spacers progress toward the center from the sides of the liquid crystal panel, the compressive strains of the column spacers are reduced as the column spacers get toward the center from the side of the liquid crystal panel. Therefore, the uniformity of the cell gap can be ensured by preventing the cell gap from becoming nonuniform due to the deformation of the column spacers and a defect in picture quality caused by the nonuniformity of the cell gap can be prevented.

While the invention has been shown and described with reference to embodiments thereof, it will be understood by those skilled in the art that various changes in form and details may be made therein without departing from the spirit and scope of the invention as defined by the appended claims.

What is claimed is:

1. A liquid crystal panel comprising:
first and second substrates assembled by a seal line with a liquid crystal interposed therebetween; and
a plurality of column spacers disposed between the first and second substrates to maintain a cell gap between the first substrate and the second substrate substantially constant, the plurality of column spacers has respective side tilt angles that are differently formed according to their locations in the liquid crystal panel.

2. The liquid crystal panel as claimed in claim 1, wherein the liquid crystal panel is divided into a plurality of regions, and the side tilt angles of the plurality of column spacers in the same region are substantially same.

3. The liquid crystal panel as claimed in claim 2, wherein the side tilt angle of the column spacer in a region distant from the seal line is larger than the side tilt angle of the column spacer in another region close to the seal line.

4. The liquid crystal panel as claimed in claim 1, wherein the side tilt angle of the column spacer distant from the seal line is larger than the side tilt angle of the column spacer close to the seal line.

5. The liquid crystal panel as claimed in claim 4, wherein the side tilt angles of the plurality of column spacers gradually increase as the column spacers become more distant from the seal line.

6. The liquid crystal panel as claimed in claim 1, wherein the plurality of column spacers are formed such that an area difference between a first bottom side of each of the plurality of column spacers and a second bottom side of each of the plurality of column spacers is smaller in a center of the liquid crystal panel than in side adjacent to the seal line, the first and second bottom sides of each of the plurality of column spacers being in contact with the first and second substrates respectively.

7. The liquid crystal panel as claimed in claim 6, wherein the plurality of column spacers are formed such that first areas of respective first bottom side of the plurality of column spacers that are in contact with the first substrate are substantially identical to each other, and second areas of respective second bottom side that are in contact with the second substrate are larger in a center of the liquid crystal panel than in side adjacent to the seal line.

8. A liquid crystal panel comprising:
first and second substrates assembled by a seal line with a liquid crystal interposed therebetween; and
a plurality of column spacers disposed between the first and second substrates to maintain a cell gap between the first substrate and the second substrate substantially constant,
wherein the first and second substrates are divided into a plurality of regions, and a side tilt angle of the column spacer is larger in first region distant from the seal line than in second region close to the seal line.

9. The liquid crystal panel as claimed in claim 8, wherein the side tilt angles of the plurality of column spacers in the same region are substantially same.

10. The liquid crystal panel as claimed in claim 8, wherein the plurality of column spacers are formed such that an area difference between a first and second bottom sides of each of the plurality of column spacers is smaller in the first region than the second region, the first and second bottom sides of each of the plurality of column spacers being in contact with the first and second substrates respectively.

11. A liquid crystal panel comprising:
first and second substrates assembled by a seal line with a liquid crystal interposed therebetween; and
a plurality of column spacers disposed between the first and second substrates to maintain a cell gap between the first substrate and the second substrate substantially constant,
wherein a side tilt angle of the column spacer distant from the seal line is larger than the side tilt angle of the column spacer close to the seal line.

12. The liquid crystal panel as claimed in claim 11, wherein the side tilt angles of the plurality of column spacers gradually increase as the column spacers become more distant from the seal line.

13. The liquid crystal panel as claimed in claim 12, wherein the plurality of column spacers are formed such that an area difference between a first and second bottom sides of each of the plurality of column spacers is smaller in a center of the liquid crystal panel than in side adjacent to the seal line, the first and second bottom sides of each of the plurality of column spacers being in contact with the first and second substrates respectively.

14. A method for manufacturing a liquid crystal panel, comprising the steps of:
forming a plurality of column spacers of which respective side tilt angles are different according to their locations on any one of first and second substrates;
forming a seal line on any one of the first and second substrates;
forming a liquid crystal layer on any one of the first and second substrates; and
assembling the first and second substrates.

15. The method as claimed in claim 14, wherein the plurality of column spacers are formed by using a diffraction exposure mask having a plurality of slits.

16. The method as claimed in claim 15, wherein the liquid crystal panel is divided into a plurality of regions, and an amount of diffraction exposure of the slits located corresponding to the same region of the liquid crystal panel is substantially same.

17. The method as claimed in claim 16, wherein the amount of diffraction exposure of the slits is larger at first slit located corresponding to first region close to the seal line of the liquid crystal panel than at second slit located corresponding to second region close to the seal line.

18. The method as claimed in claim 15, wherein the amount of diffraction exposure of the slits is gradually increases as the location of the slits become closer to the seal line.
